(19) United States
(12) Patent Application Publication
(10) Pub. No.: US 2016/0351120 A1
(43) Pub. Date: Dec. 1, 2016

(54) DISPLAY DEVICE AND METHOD FOR DRIVING DISPLAY DEVICE

(71) Applicant: JOLED INC., Tokyo (JP)

(72) Inventor: Shunsuke ITAKURA, Tokyo (JP)

(73) Assignee: JOLED INC., Tokyo (JP)

(21) Appl. No.: 15/117,235

(22) PCT Filed: Dec. 22, 2014
(86) PCT No.: PCT/JP2014/006401

§ 371 Date: Aug. 8, 2016

(30) Foreign Application Priority Data
Feb. 10, 2014 (JP) 2014-023820

(51) Int. Cl. G09G 3/3233

(52) U.S. Cl. CPC G09G 3/3233; G09G 2300/0819; G09G 2330/028; G09G 2310/08; G09G 2320/0233; G09G 2310/0251

(57) ABSTRACT

A display device includes a plurality of pixels arranged in a matrix. Each of the pixels includes a light-emitting element, a capacitance element; a drive transistor which supplies, to the light-emitting element, a current corresponding to the amount of the electric charge accumulated in the capacitance element; a first switch transistor for pre-initializing the electric charge accumulated in the capacitance element; and a second switch transistor for, after the pre-initializing, further initializing the electric charge accumulated in the capacitance element. The display device further includes: a first voltage source which outputs a first voltage (Vref2) to the capacitance element when the first switch transistor is turned on; and a second voltage source which applies a second voltage (Vref1) to the capacitance element when the second switch transistor is turned on.

### TECHNICAL FIELD

The present disclosure relates to a display device such as an image display device including, for example, organic electroluminescent (hereinafter, may be referred to as EL or OLED) elements.

### BACKGROUND ART

An active-matrix (hereinafter may be abbreviated to AM) display device including organic EL elements arranged in a matrix has been adopted for use in a display panel of, for example, a smartphone, and commercialized. In recent years, a display device including organic EL elements as display elements is being sold.

In a conventional display panel including organic EL elements, when the display panel is turned on, the load of a current flowing through each power line varies due to the influences of the vertical blanking period or display state. This varies the amount of voltage ripple in each power line, causing dark lines or dark zones in a display image.

In order to reduce such a display unevenness, for example, Patent Literature (PTL) 1 discloses a technique of detecting a cathode current of an organic EL light-emitting element in a vertical blanking period and rapidly and accurately making a correction based on the detected current (for example, see PTL 1)

### CITATION LIST

### Patent Literature

[PTL 1] Japanese Unexamined Patent Application Publication No. 2008-129183

### SUMMARY OF INVENTION

### Technical Problem

In a conventional technique, in order to reduce variations in initialization voltage caused when a current load varies, for example, as in PTL 1, correction by software control or power supply feedback (FB) control is performed. This reduces display unevenness due to variations in initialization voltage.

However, due to a panel wiring resistance in the power supply feedback control method, variations in initialization voltage can be reduced, but cannot be eliminated. In the correction through software control, killer patterns are innumerable, and there is always a difference between the correction and the correction target.

The present disclosure has been conceived in view of the above problems. An object of the present disclosure is to provide a display device and a method for driving the display device capable of displaying video signals with no output deviation while eliminating variations in initialization voltage.

### Solution to Problem

The display device according to the present disclosure is a display device including a plurality of pixels arranged in a matrix. Each of the plurality of pixels includes: a light-emitting element which emits light when a current flows through the light-emitting element; a capacitance element which accumulates an electric charge corresponding to a magnitude of a video signal applied to a data line; a drive transistor which supplies, to the light-emitting element, a current corresponding to an amount of the electric charge accumulated in the capacitance element; a first switch transistor for pre-initializing the electric charge accumulated in the capacitance element; and a second switch transistor for, after the pre-initializing, further initializing the electric charge accumulated in the capacitance element. The display device further includes: a first voltage source which outputs a first voltage to the capacitance element when the first switch transistor is turned on; and a second voltage source which applies a second voltage to the capacitance element when the second switch transistor is turned on.

### Advantageous Effects of Invention

The present disclosure provides a display device and a method for driving the display device capable of displaying video signals with no output deviation while eliminating variations in initialization voltage.

### BRIEF DESCRIPTION OF DRAWINGS

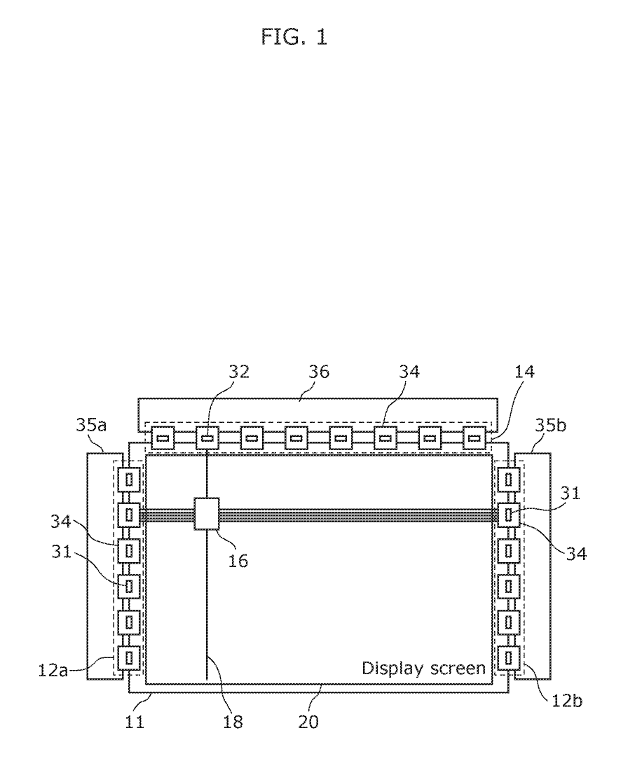

### [FIG. 1]

FIG. 1 schematically illustrates a structure of a display device according to Embodiment.

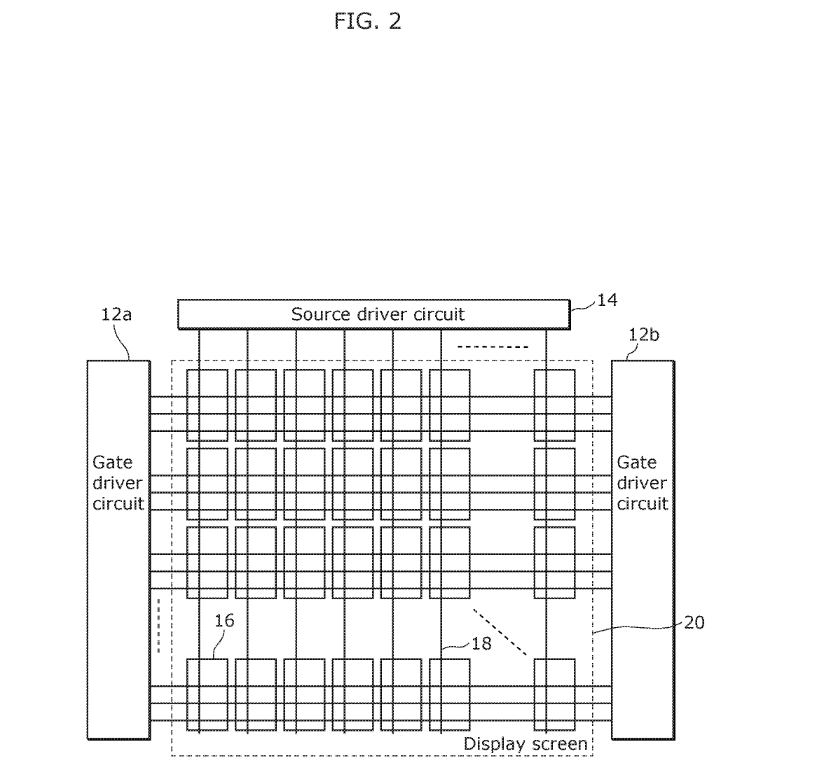

### [FIG. 2]

FIG. 2 is a block diagram illustrating a structure of the display device according to Embodiment.

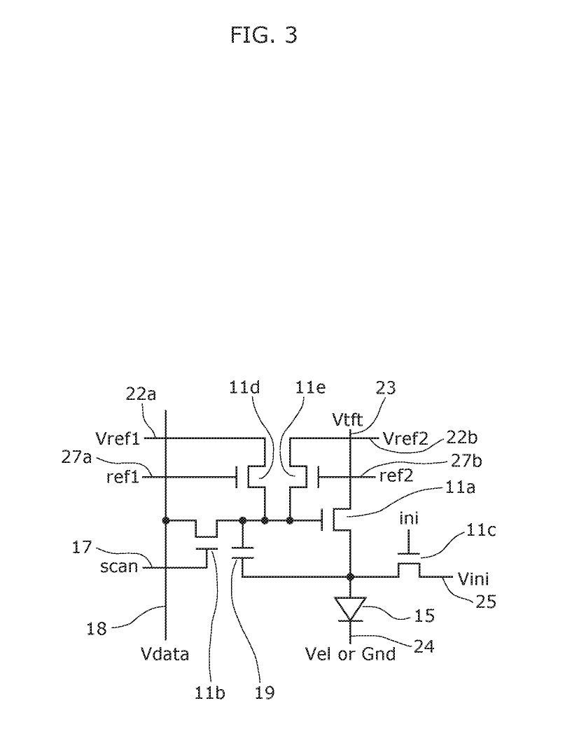

### [FIG. 3]

FIG. 3 is a diagram of a pixel circuit in the display device according to Embodiment.

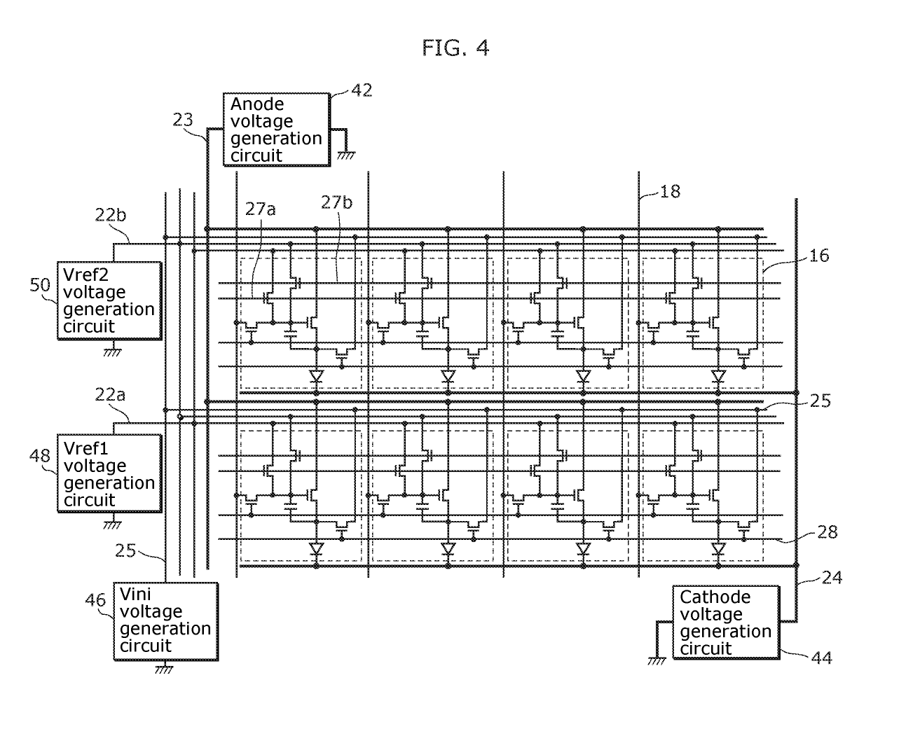

### [FIG. 4]

FIG. 4 schematically illustrates a structure of the display device according to Embodiment.

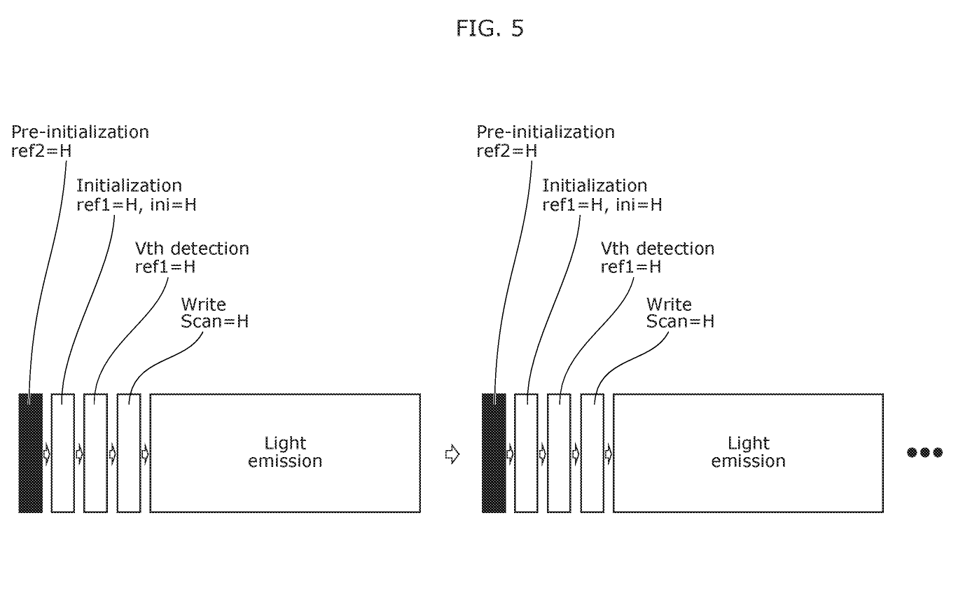

### [FIG. 5]

FIG. 5 illustrates an operation of the display device according to Embodiment.

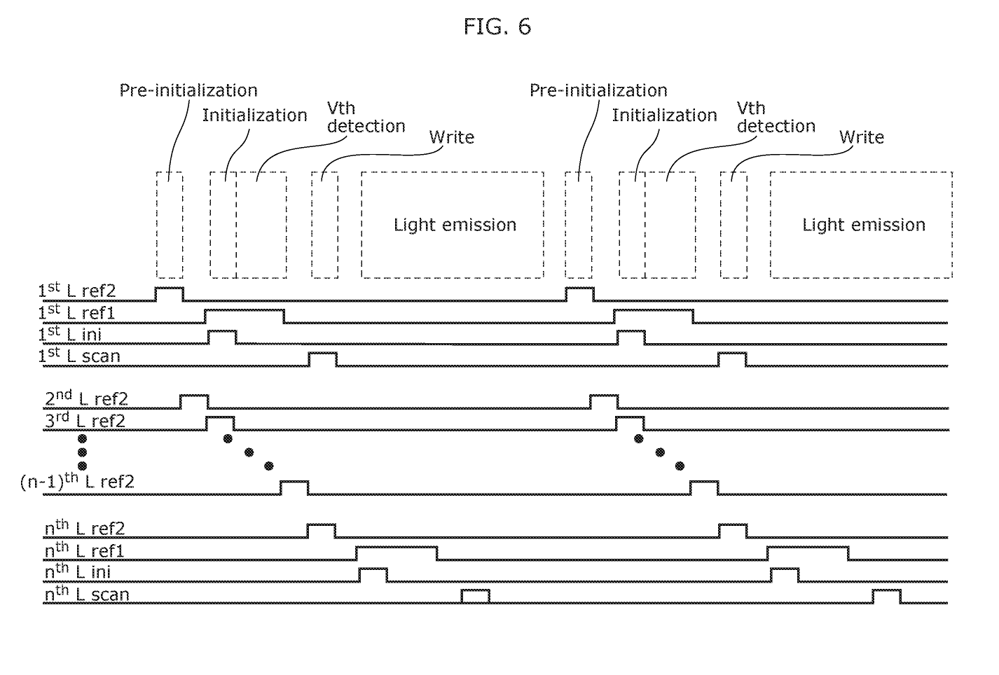

### [FIG. 6]

FIG. 6 is a timing chart showing an operation of the display device according to Embodiment.

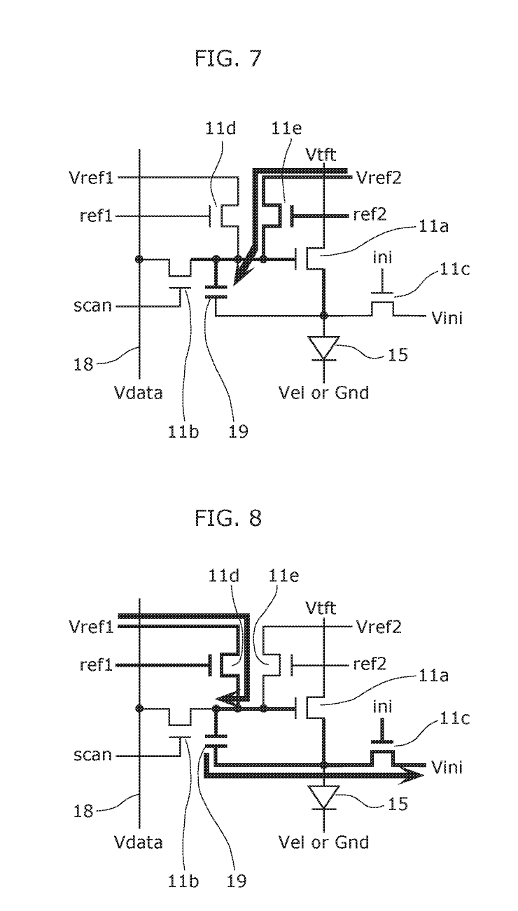

### [FIG. 7]

FIG. 7 illustrates an operation of a pixel in a pre-initialization period.

### [FIG. 8]

FIG. 8 illustrates an operation of the pixel in an initialization period.

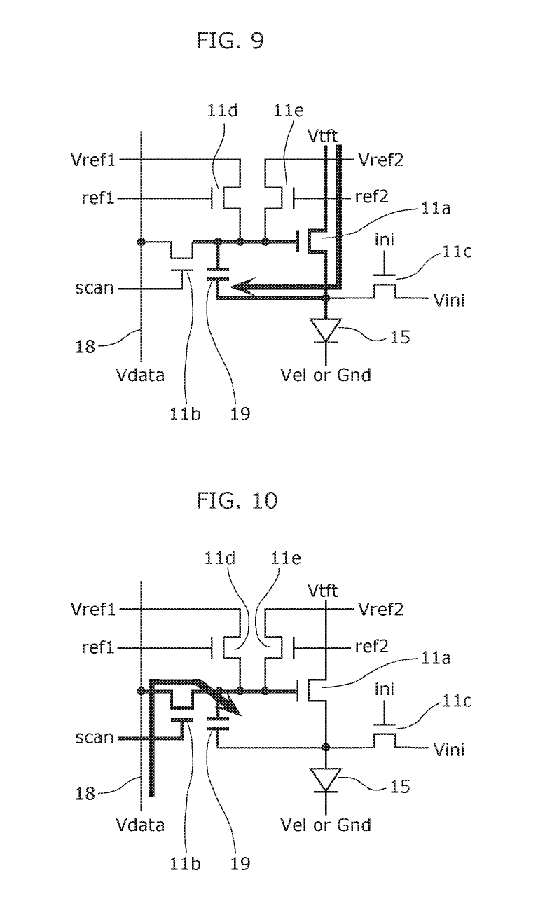

### [FIG. 9]

FIG. 9 illustrates an operation of the pixel in a Vth securing period.

### [FIG. 10]

FIG. 10 illustrates an operation of the pixel in a write period.

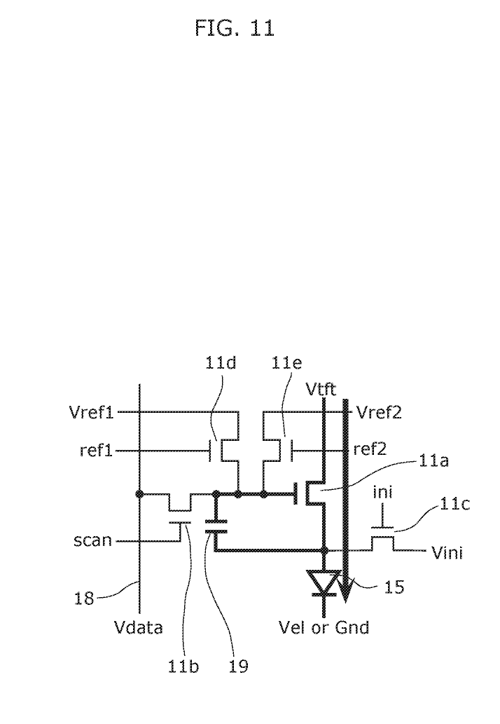

### [FIG. 11]

FIG. 11 illustrates an operation of the pixel in a light emission period.

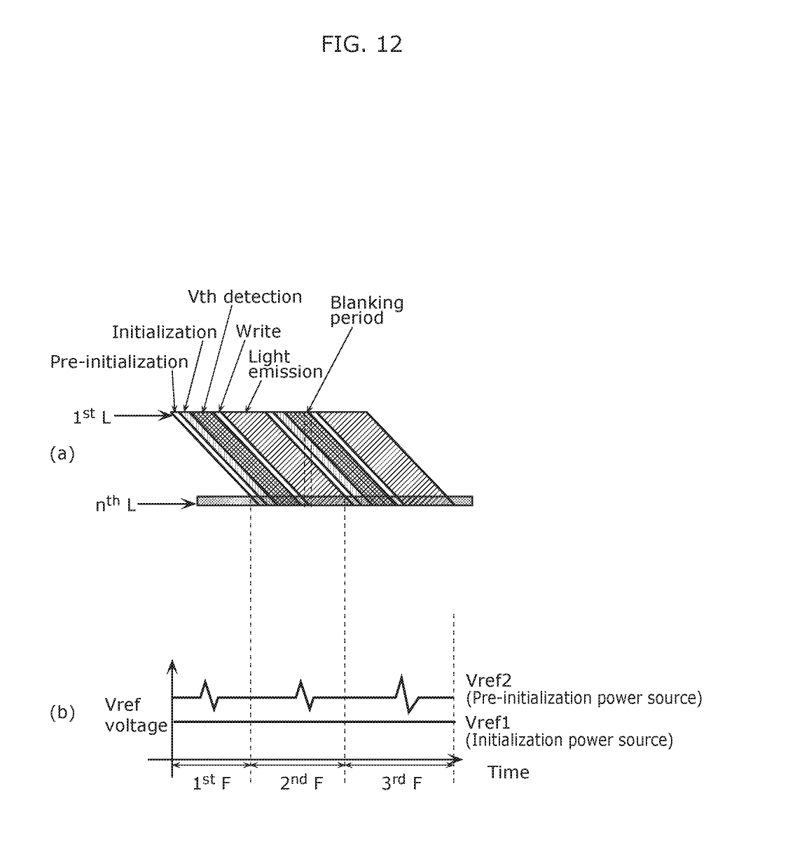

### [FIG. 12]

FIG. 12 illustrates effects of the display device according to Embodiment.

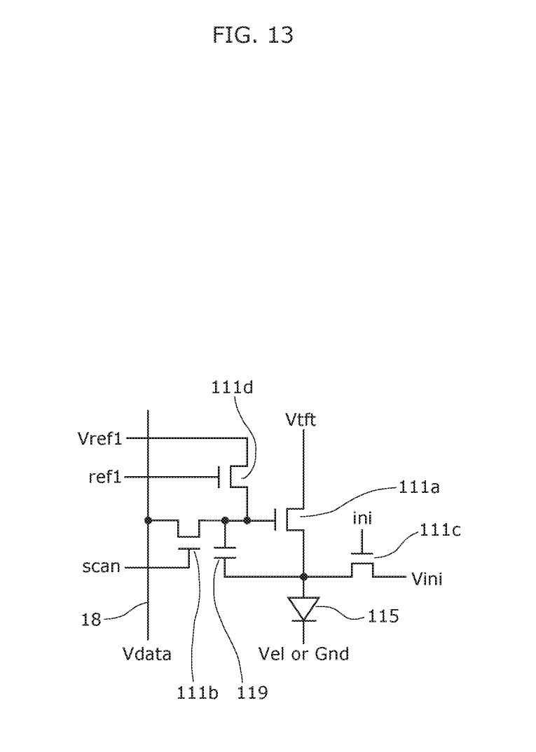

### [FIG. 13]

FIG. 13 is a diagram of a pixel circuit in a display device according to a conventional technique.

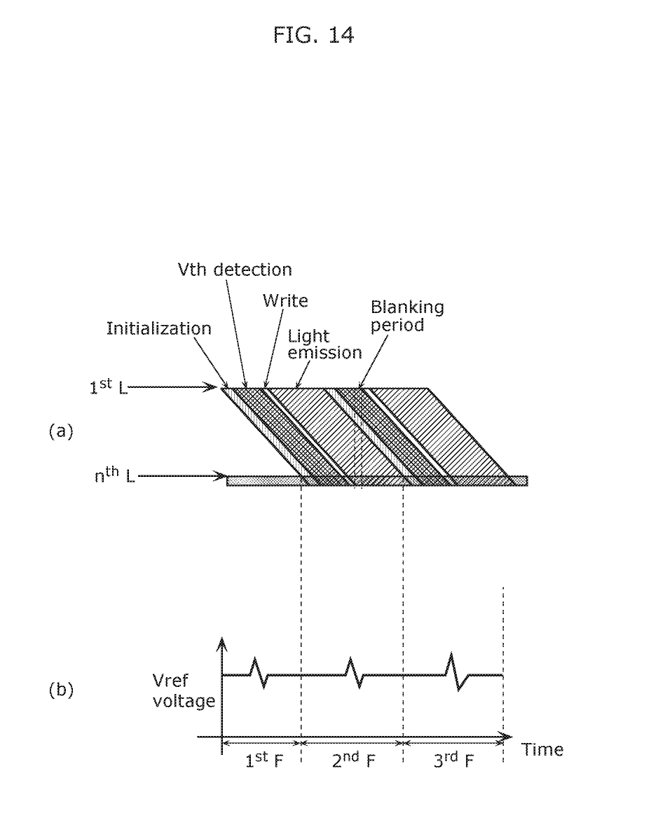

### [FIG. 14]

FIG. 14 illustrates video displayed by the display device according to the conventional technique.

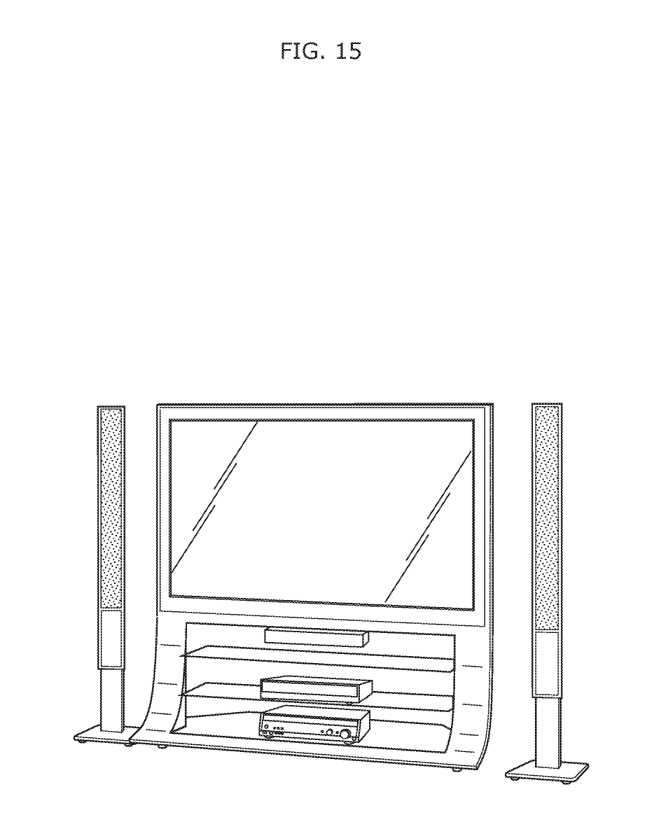

### [FIG. 15]

FIG. 15 is an external view of a thin-flat television(TV) including the display device according to Embodiment.

### DESCRIPTION OF EMBODIMENTS

### Underlying Knowledge Forming Basis of the Present Disclosure

The inventor found the following problems in connection with an active-matrix organic EL display described in the “Background Art” section. Hereinafter, the problems will be described.

FIG. 13 is a diagram of a pixel circuit in a display device according to a conventional technique. FIG. 14 illustrates video displayed by the display device according to the conventional technique.

As FIG. 13 illustrates, each pixel in the display device according to the conventional technique includes: a drive transistor 111a; switch transistors 111b; 111c; and 111d; an organic EL element 115; and a capacitance element 119.

In FIG. 14, (a) is an operation transition diagram illustrating a progressive drive method of an organic EL light-emitting panel. In (a) of FIG. 14, the horizontal axis indicates time, and the vertical axis indicates pixel rows (display rows). (a) of FIG. 14 illustrates that, in a display panel including a plurality of pixels arranged in a matrix, an initialization operation, a Vth (threshold voltage) detection operation, a write operation, and a light emission operation are sequentially performed row by row. (a) of FIG. 14 illustrates the first row (1^{st} L) to n^{th} row (n^{th} L) of the display panel. For example, in (a) of FIG. 14, n is 2160. In (b) of FIG. 14, the horizontal axis indicates time, and the vertical axis indicates initialization voltage (Vref voltage). In (b) of FIG. 14, the 1^{st} F, the 2^{nd} F, and the 3^{rd} F along the horizontal axis respectively indicate the first field, the second field, and the third field in video to be displayed.

In other words, when video is to be displayed in the display device, as (a) of FIG. 14 illustrates, the initialization operation, the Vth detection operation, the write operation, and the light emission operation are sequentially performed on the pixel circuits from the first row (1^{st} L) which is the top row to the n^{th} row (n^{th} L) which is the last row. Here, a vertical blanking period is provided between the end of the write period for the n^{th} row in a given frame and the start of the write period for the first row in the next frame.

For example, (a) of FIG. 14 illustrates virtual rows (for example, 2161^{th} row to 2253^{th} row) serving as blanking rows after the n^{th} L. The blanking rows correspond to a vertical blanking period for ensuring a time taken for a gate driver to return the row to be scanned (scanning row) from the last row (2160^{th} row) to the top row (1^{st} row). The blanking rows are represented by the number of scanning rows corresponding to the vertical blanking period.

The vertical blanking period is a blanking period included in a video signal externally input, and is a period for returning the scanning row from the last row to the top row in scanning of a video signal in a cathode-ray tube. In an organic EL display, such a vertical blanking period is technically unnecessary. However, since a video signal includes such a period, an organic EL display device needs to comply with the display scheme of such a video signal. Hence, the vertical blanking period is provided.

Here, in the case where the vertical blanking period overlaps with the initialization period for another row, initialization voltage varies, as illustrated in (b) of FIG. 14. In other words, when the panel is turned on, the load of a current flowing through each power line varies due to the influences of the vertical blanking period or display state, which varies the amount of voltage ripple in each power line. Hence, the electric charge charged in the capacitance element 119 varies, which results in darkening or brightening the row being initialized in the blanking period or causing dark lines or dark zones in a display image.

Additionally, in the conventional technique, in order to reduce variations in initialization voltage caused when the current load varies, display unevenness is reduced by power supply feedback (FB) control or correction through software control. However, due to a wiring resistance in the power supply feedback control method, variations in voltage can be reduced, but cannot be eliminated. In the correction through software control, killer patterns are innumerable, and there is always a difference between the correction and the correction target.

In order to solve such problems, the display device according to one aspect of the present disclosure is a display device including a plurality of pixels arranged in a matrix. Each of the plurality of pixels includes: a light-emitting element which emits light when a current flows through the light-emitting element; a capacitance element which accumulates an electric charge corresponding to a magnitude of a video signal applied to a data line; a drive transistor which supplies, to the light-emitting element, a current corresponding to an amount of the electric charge accumulated in the capacitance element; a first switch transistor for pre-initializing the electric charge accumulated in the capacitance element; and a second switch transistor for, after the pre-initializing, further initializing the electric charge accumulated in the capacitance element. The display device further includes: a first voltage source which outputs a first voltage to the capacitance element when the first switch transistor is turned on; and a second voltage source which applies a second voltage to the capacitance element when the second switch transistor is turned on.

With the structure, it is possible to provide a display device which is capable of eliminating variations in initialization voltage without output deviation of video signals.

Furthermore, it may be that the first voltage and the second voltage have different values.

With the structure, a voltage applied to the capacitance element during the initialization period can be stabilized without being affected by a noise signal transmitted through the same voltage source.

Moreover, it may be that the first voltage is greater than the second voltage.

With the structure, a voltage applied to the capacitance element can be further stabilized during the initialization period subsequent to the pre-initialization period.

Moreover, a method for driving the display device according to one aspect of the present disclosure is a method for driving a display device including a plurality of pixels arranged in a matrix. The method includes: pre-initializing an electric charge accumulated in a capacitance element disposed in each of the plurality of pixels; after the pre-initializing, initializing again the electric charge accumulated in the capacitance element; detecting a threshold voltage of a drive transistor disposed in each of the plurality of pixels; accumulating, in the capacitance element, an electric charge corresponding to a magnitude of a video signal; and supplying, to the light-emitting element, a current corresponding to an amount of the electric charge accumulated in the capacitance element to cause the light-emitting element to emit light.

Moreover, it may be that in the pre-initializing, a first voltage is applied to the capacitance element from a first voltage source by turning on a first switch transistor; and in the second initializing, a second voltage is applied to the capacitance element from a second voltage source by turning on a second switch transistor.

With the structure, it is possible to provide a method for driving a display device capable of eliminating variations in initialization voltage without output deviation of video signals.

Furthermore, it may be that the first voltage and the second voltage have different values.

With the structure, a voltage applied to the capacitance element during the initialization period can be stabilized without being affected by a noise signal transmitted through the same voltage source.

Moreover, it may be that the first voltage is greater than the second voltage.

With the structure, a voltage applied to the capacitance element during the initialization period subsequent to the pre-initialization period can be further stabilized.

### Embodiment

Hereinafter, an embodiment will be described in detail with reference to the drawings where necessary. Note, however, that detailed descriptions may be omitted where unnecessary. For example, detailed descriptions of well-known aspects or repetitive descriptions of essentially similar configurations may be omitted. This is to avoid redundancy and make the following description easier for those skilled in the art to understand.

Note that the inventor provides the accompanying drawings and the following description not to limit the scope of the claims, but to aid those skilled in the art to adequately understand the present disclosure.

### 1. Structure of Display Device

FIG. 1 schematically illustrates a structure of a display device according to the present embodiment. FIG. 2 is a block diagram illustrating a structure of the display device according to the present embodiment. FIG. 3 is a diagram of a pixel circuit 16 in the display device according to the present embodiment.

As FIG. 1 and FIG. 2 illustrate, the display device according to the present embodiment includes: a display screen 20; chip on films (COFs) 34; gate printed circuit boards 35a and 35b; and a source printed circuit board 36.

The COFs 34 include circuits 31 forming a gate driver or circuits 32 forming a source driver. The COFs 34 including the circuits 31 are arranged so as to connect the display screen 20 and the gate printed circuit board 35a or 35b. The COFs 34 including the circuits 32 are arranged so as to connect the display screen 20 and the source printed circuit board 36. The COFs 34 are connected to the display screen 20, the gate printed circuit boards 35a and 35b, and the source printed circuit board 36 with anisotropic conductive film (ACF) resin.

In the following description, a plurality of circuits 31 disposed between the display screen 20 and the gate printed circuit board 35a are collectively referred to as a gate driver circuit 12a. A plurality of circuits 31 disposed between the display screen 20 and the gate printed circuit board 35b are collectively referred to as a gate driver circuit 12b. A plurality of circuits 32 disposed between the display screen 20 and the source printed circuit board 36 are collectively referred to as a source driver circuit 14.

The gate driver circuits 12a and 12b are connected to scan lines 17. The gate driver circuits 12a and 12b apply, to the scan lines 17, a control voltage for turning on or off switch transistors 11b to 11e disposed in each pixel 16 to be described. The source driver circuit 14 is connected to data lines 18, and applies a video signal to the data lines 18.

The display screen 20 includes a plurality of pixels 16 arranged in a matrix. As FIG. 2 illustrates, the pixels 16 are connected to: the scan lines 17 electrically connected to the gate driver circuit 12a or 12b; and the data lines 18 electrically connected to the source driver circuit 14.

As FIG. 3 illustrates, each pixel 16 includes: an organic EL element 15; a drive transistor 11a; switch transistors 11b to 11e; and a capacitance element 19. Moreover, in the pixel 16; a reference power line 22a (Vref1), a reference power line 22b (Vref2), an EL anode power line 23 (Vtft), an EL cathode power line 24 (Vel), an initialization power line 25 (Vini), a scan line 17 (scan), a reference voltage control line 27a (ref1), a reference voltage control line 27b (ref2), an initialization control line 28 (ini), and a data line 18 (Vdata) are arranged. In the capacitance element 19, an electrode connected to the gate electrode of the drive transistor 11a is referred to as a first electrode, and an electrode connected to the anode of the organic EL element 15 is referred to as a second electrode.

FIG. 4 schematically illustrates a structure of the display device according to the present embodiment. As FIG. 4 illustrates, the display device includes: an anode voltage generation circuit 42; a cathode voltage generation circuit 44; a Vini voltage generation circuit 46; a Vref1 voltage generation circuit 48; and a Vref2 voltage generation circuit 50.

The anode voltage generation circuit 42 is connected to the EL anode power line 23 (Vtft) and generates an anode voltage to be applied to the organic EL elements 15. The cathode voltage generation circuit 44 is connected to the EL cathode power line 24 (Vel) and generates a cathode voltage to be applied to the organic EL elements 15. The EL cathode power line 24 (Vel) may be grounded instead of being connected to the cathode voltage generation circuit 44. The Vini voltage generation circuit 46 is connected to the initialization power lines 25 (Vini), and generates an initialization voltage Vini for initializing the capacitance elements 19. The Vref1 voltage generation circuit 48 generates an initialization voltage Vref1 for initializing the capacitance elements 19. The Vref2 voltage generation circuit 50 generates an initialization voltage Vref2 for pre-initializing the capacitance elements 19. Providing the Vref1 voltage generation circuit 48 and the Vref2 voltage generation circuit 50 allows the voltage Vref1 and the voltage Vref2 to be supplied from different voltage sources in an initialization period. Hence, a voltage to be applied to the capacitance elements 19 can be further stabilized.

The switch transistors 11e and 11d respectively correspond to the first transistor and the second transistor according to the present disclosure. The Vref2 voltage generation circuit 50 and the Vref1 voltage generation circuit 48 respectively correspond to the first voltage source and the second voltage source according to the present disclosure. The voltage Vref2 and the Voltage Vref1 respectively correspond to the first voltage and the second voltage according to the present disclosure.

### 2. Method for Driving Display Device

Next, a method for driving the display device will be described. FIG. 5 illustrates an operation of the display device according to the present embodiment. FIG. 6 is a timing chart showing an operation of the display device according to the present embodiment.

As FIG. 5 illustrates, in the display device according to the present embodiment, when an image is displayed on a display, a pre-initialization operation, an initialization operation, a threshold voltage (Vth) detection operation, a write operation, and a light emission operation are sequentially performed per row (1L).

In FIG. 6, the horizontal axis indicates time, and the vertical axis indicates, voltage signals applied to the reference voltage control line 27b (ref2), the reference voltage control line 27a (ref1), the initialization control line 28 (ini), and the scan line 17 (scan) in the pixels 16 in each row. As FIG. 6 illustrates, a series of the pre-initialization operation, the initialization operation, the threshold voltage (Vth) detection operation, the write operation, and the light emission operation is performed sequentially from the top 1^{st} row to the last n^{th} row.

Here, as the 1^{st} L in FIG. 6 illustrates, in the pre-initialization operation, a high-level voltage is applied to the reference voltage control line 27b (ref2). In the initialization operation, a low-level voltage is applied to the reference voltage control line 27b (ref2), and a high-level voltage is applied to the reference voltage control line 27a (ref1) and the initialization control line 28 (ini). Subsequently, in the Vth detection operation, a low-level voltage is applied to the initialization control line 28 (ini). In the write operation, a low-level voltage is applied to the reference voltage control line 27b (ref2), the reference voltage control line 27a (ref1), and the initialization control line 28 (ini), and a high-level voltage is applied to the scan line 17 (scan).

The pre-initialization operation and the initialization operation are respectively a first initialization and a second initialization according to the present disclosure.

The following describes the operations of the pixel 16 in each operation period. FIG. 7 to FIG. 11 each illustrate an operation of the pixel 16 in each operation period. FIG. 12 illustrates the effects of the display device according to the present embodiment. In FIG. 12, (a) illustrates an operating state (display video) of pixels in a given column in time series, and (b) illustrates the voltage Vref in a given pixel in the same column as that in (a).

### 2-1. Pre-Initialization Period

First, the pre-initialization period will be described. FIG. 7 illustrates an operation of the pixel 16 in a pre-initialization period.

The pre-initialization period refers to a period preceding an initialization period, and a period provided for applying a stable voltage to the capacitance element 19 when an electric charge is charged in the capacitance element 19 during the initialization period. By providing the pre-initialization period, in each pixel in the rows on which initialization is performed during the blanking period, a voltage applied to the capacitance element 19 can be further stabilized in the initialization period subsequent to the pre-initialization period.

In the pre-initialization period, the voltage Vref2 is applied to the first electrode of the capacitance element 19 and the gate of the drive transistor 11a. Specifically, the voltage level of the reference voltage control line 27b is changed from low to high, causing the switch transistor 11e to turn on. Accordingly, as FIG. 7 illustrates, the voltage Vref2 is charged in the capacitance element 19 via the reference power line 22b from the Vref2 voltage generation circuit 50. The voltage waveform of the voltage Vref2 at this time will be described later.

The voltage Vref2 may be output from the Vref2 voltage generation circuit 50 serving as a voltage source. If the voltage source which generates the voltage Vref 2 is not the same as the Vref1 voltage generation circuit 48 serving as a voltage source which generates the voltage Vref1, the voltage Vref2 may be shared with the anode voltage generation circuit 42, the cathode voltage generation circuit 44, and the Vini voltage generation circuit 46.

### 2-2. Initialization Period

Next, the initialization period will be described. FIG. 8 illustrates an operation of the pixel 16 in an initialization period.

The initialization period refers to a period during which a voltage necessary to apply a drain current in the detection period of Vth of the drive transistor 11a is charged in the capacitance element 19.

In the initialization period, a high-level voltage is applied to the initialization control line 28 (ini) first, causing only the switch transistor 11c to be conductive (to turn on). Accordingly, the source potential of the drive transistor 11a is set to the voltage Vini, which stabilizes the source potential of the drive transistor 11a.

Next, a voltage necessary to apply a drain current to detect the threshold voltage of the drive transistor 11a in the subsequent Vth detection period is applied to the first electrode of the capacitance element 19 and the gate of the drive transistor 11a in advance. Specifically, the voltage level of the reference voltage control line 27a is changed from low to high, causing the switch transistor 11d to turn on. Accordingly, as FIG. 8 illustrates, the voltage Vref1 is charged in the capacitance element 19 via the reference power line 22a from the Vref1 voltage generation circuit 48.

Subsequently, a low-level voltage signal is applied to the initialization control line 28 (ini), causing the switch transistor 11c to be non-conductive (to turn off). With this, the initialization period ends. The voltage waveform of the voltage Vref1 at this time will be described later.

The magnitudes of the Vref1 and the Vref2 may be different. The magnitude of the Vre2 may be greater than that of the Vref1. With this, a voltage applied to the capacitance element 19 can be further stabilized during the initialization period subsequent to the pre-initialization period.

### 2-3. Vth Detection Period

Next, a Vth detection period will be described. FIG. 9 illustrates an operation of the pixel 16 in a Vth detection period.

The Vth detection period refers to a period during which the threshold voltage of the drive transistor 11a is detected in the capacitance element 19.

In the Vth detection period, the threshold voltage of the drive transistor 11a is detected in the capacitance element 19. Specifically, the voltage levels of the scan line 17 and the initialization control line 28 are maintained low, and the voltage level of the reference voltage control line 27a is maintained high. In other words, the switch transistors 11b and 11c are turned off and the switch transistor 11d is turned on.

Here, as FIG. 9 illustrates, a drain current flows through the drive transistor 11a while no current is flowing through the organic EL element 15 due to the voltage setting in the initialization period, and the source potential of the drive transistor 11a is changed. In other words, the source potential of the drive transistor 11a is changed till the drain current supplied by the voltage Vtft of the EL anode power line 23 reaches 0. In such a manner, the detection operation of the threshold voltage of the drive transistor 11a starts.

At the end of the Vth detection period, the potential difference between the first electrode and the second electrode (the electrode connected to the anode of the organic EL element 15) of the capacitance element 19 (the gate-source voltage of the drive transistor 11a) corresponds to the threshold voltage Vth of the drive transistor 11a. Subsequently, a low-level voltage is applied to the reference voltage control line 27a, causing the switch transistor 11d to turn off. Accordingly, supply of the drain current to the drive transistor 11a is stopped, completing the threshold voltage detection operation.

Before a high-level voltage is applied to the scan line 17 in the subsequent write period, a low-level voltage is applied to the reference voltage control line 27a to turn off the switch transistor 11d. Specifically, while the voltage levels of the initialization control line 28 and the scan line 17 are maintained low, the voltage level of the reference voltage control line 27a is changed from high to low. Accordingly, it is possible to prevent a data signal voltage supplied to the data line 18 and the voltage Vref1 of the reference power line 22a from being applied to the first electrode (the electrode which is not connected to the organic EL element 15) of the capacitance element 19 at the same time in the subsequent write period.

### 2-4. Write Period

Next, a write period will be described. FIG. 10 illustrates an operation of the pixel 16 in a write period.

The write period refers to a period during which a video signal voltage (data signal voltage) corresponding to the display gray scale is supplied from the data line 18 to the pixel 16 and written into the capacitance element 19 of the pixel 16.

In the write period, the write operation is prepared by first causing the switch transistor 11b to turn on for a predetermined period. Specifically, the voltage level of the scan line 17 is changed from low to high. At that time, the switch transistors 11c, 11d, and 11e, and the drive transistor 11a are off.

Next, as FIG. 10 illustrates, a video signal voltage (data signal voltage) corresponding to the display gray scale is supplied to the pixel 16 from the data line 18 and written into the capacitance element 19. Specifically, a data signal voltage is applied to the first electrode of the capacitance element 19 via the data line 18 and the switch transistor 11b. Accordingly, in addition to the threshold voltage Vth of the drive transistor 11a held in the Vth detection period, the voltage difference between the data signal voltage and the voltage Vref is multiplied by (the parasitic capacitance of the organic EL element 15)/(the parasitic capacitance of the organic EL element 15+the electrostatic capacitance of the capacitance element 19), and held in the capacitance element 19.

### 2-5. Light Emission Period

Next, a light emission period will be described. FIG. 11 illustrates an operation of the pixel 16 in a light emission period.

The light emission period refers to a period during which the organic EL element 15 emits light at the gray scale corresponding to the magnitude of the video signal voltage (data signal voltage) written into the capacitance element 19.

Specifically, the voltage levels of the scan line 17, the reference voltage control line 27a, and the initialization control line 28 are maintained low. In other words, the switch transistors 11b, 11d, and 11c are maintained off.

Accordingly, a voltage corresponding to the electric charge accumulated in the capacitance element 19 is applied to the gate of the drive transistor 11a, causing the drive transistor 11a to turn on. As FIG. 11 illustrates, a current corresponding to the magnitude of the electric charge accumulated in the capacitance element 19 is supplied to the organic EL element 15 via the EL anode power line 23 (Vtft). Accordingly, the organic EL element 15 emits light according to the magnitude of the electric charge accumulated in the capacitance element 19.

### 3. Effects etc.

FIG. 12 illustrates the effects of the display device according to the present embodiment. In FIG. 12, (a) illustrates an operating state (display image) of pixels in a given column in time series, and (b) illustrates the voltage Vref in a given pixel in the same column as that in (a).

In FIG. 12, (a) is an operation transition diagram illustrating a progressive drive method of an organic EL light-emitting panel. In (a) of FIG. 12, the horizontal axis indicates time, and the vertical axis indicates pixel rows (display rows). (a) of FIG. 12 illustrates that, in a display panel including a plurality of pixels arranged in a matrix, a pre-initialization operation, an initialization operation, a Vth (threshold voltage) detection operation, a write operation, and a light emission operation are sequentially performed row by row. (a) of FIG. 12 illustrates the 1^{st} row (1^{st} L) to the n^{th} row (n^{th} L) of the display panel. For example, in (a) of FIG. 12, n is 2160. In (b) of FIG. 12, the horizontal axis indicates time, and the vertical axis indicates initialization voltage (Vref voltage). The 1^{st} F, the 2^{nd} F, and the 3^{rd} F along the horizontal axis in (b) of FIG. 12 respectively indicate the first field, the second field, and the third field in video to be displayed.

For example, (a) of FIG. 12 illustrates virtual rows (for example, 2161^{th} row to 2253^{th} row) serving as blanking rows after the n^{th} L. The blanking rows correspond to a vertical blanking period for ensuring the time taken for a gate driver to return the scanning row from the last row (2160^{th} row) to the top row (1^{st} row). The blanking rows are represented in the number of scanning rows corresponding to the vertical blanking period.

(b) of FIG. 12 illustrates the voltage Vref2 in the pre-initialization operation and the voltage Vref1 in the initialization operation. During the period in which the pre-initialization period overlaps the vertical blanking period, as (b) of FIG. 12 illustrates, the voltage Vref2 varies, but the voltage Vref1 does not vary. Accordingly, by providing the pre-initialization operation before the initialization operation, variations in initialization voltage is eliminated, allowing video signals to be displayed with no output deviation.

As describe above, according to the method for driving the display device according to the present embodiment, providing the pre-initialization operation before the initialization operation can eliminate variations in initialization voltage, allowing video signals to be displayed with no output deviation.

### Other Embodiments

Although the display device according to the above embodiment has been described thus far, the display device is not limited to the display device described above. Modifications that can be obtained by executing various modifications to the above embodiment that is conceivable to a person of ordinary skill in the art without departing from the essence of the present invention, and various devices in which the display device is provided therein are included in the present invention.

Moreover, although in the above embodiment, an example of the structure of the pixel circuit included in the display device according to the present invention has been described, the circuit structure of the pixel 16 is not limited to the above described circuit structure. In the above described embodiment, although an example of the structure in which the drive transistor 11a and the organic EL element 15 are disposed in that order between the EL anode power line 23 and the EL cathode power line 24 has been described, a switch transistor may be further included between the EL anode power line 23 and the drive transistor 11a. Accordingly, by causing the switch transistor to turn on or turn off, a current can be stably supplied to the organic EL element 15.

Moreover, the anode voltage generation circuit 42, the drive transistor 11a, and the switch transistor may be disposed in that order, or these three elements may be disposed in a different order. Specifically, in the display device according to the present invention, regardless of the drive transistor being of an n-type or a p-type, the order of the arrangement of the drive transistor 11a and the organic EL element 15 is not limited as long as the drain electrode and the source electrode of the drive transistor 11a, and the anode electrode and the cathode electrode of the organic EL element 15 are disposed along the current path between the EL anode power line 23 and the EL cathode power line 24.

Moreover, although in the above embodiment, an example of the structure of the pixel circuit included in the display device according to the present invention has been described, the circuit structure of the pixel 16 is not limited to the above described circuit structure. In the above embodiment, a switch transistor may be included between the EL anode power line 23 and the EL cathode power line 24. In that case, the switch transistor, the drive transistor 11a, and the organic EL element 15 may be arranged in that order. Moreover, the switch transistor, the drive transistor 11a, and the organic EL element 15 may be arranged in a different order. Specifically, in the display device according to the present invention, regardless of the drive transistor being of an n-type or a p-type, the order of the arrangement of the drive transistor 11a and the organic EL element 15 is not limited as long as the drain electrode and the source electrode of the drive transistor 11a, and the anode electrode and the cathode electrode of the organic EL element 15 are disposed along the current path between the EL anode power line 23 and the EL cathode power line 24.

Moreover, in the above described embodiment, although it has been assumed that the switch transistors 11b to 11e are each MOSFET having a gate electrode, a source electrode, and a drain electrode, these transistors may be bipolar transistors each having a base, a collector, and an emitter. In that case, too, the objects of the present invention are achieved, and the similar advantageous effects are produced.

Moreover, a control circuit and an operation circuit included in the display device according to the above described embodiment are typically implemented as a Large-Scale Integration (LSI) which is an integrated circuit. Note that part of the control circuit and the operation circuit included in the display device described above can also be integrated in the same substrate as the display screen 20. Furthermore, they may be implemented as a dedicated circuit or a general-purpose processor. Furthermore, a Field Programmable Gate Array (FPGA) which allows programming after LSI manufacturing or a reconfigurable processor which allows reconfiguration of the connections and settings of circuit cells inside the LSI may be used.

Furthermore, part of the functions of the scan line drive circuit, the data line drive circuit, the control circuit, and the operation circuit included in the display device according to the above embodiment may be implemented by having a processor such as a CPU executing a program.

Furthermore, although the display device according to the above embodiment is a display device including organic EL elements as an example, the present invention may be applied to a display device including light-emitting elements other than the organic EL elements.

Furthermore, for example, the display device according to the above embodiment is built into a thin flat-screen TV such as that illustrated in FIG. 15. The built-in display device according to the above embodiment allows for the realization of a thin flat-screen TV capable of displaying high-precision images with reduced display unevenness.

### INDUSTRIAL APPLICABILITY

The present invention is useful, in particular, to an active-type organic EL flat panel display.

### REFERENCE SIGNS LIST

11a, 111a drive transistor

11b, 11c, 111b, 111c switch transistor

11d, 111d switch transistor (second switch transistor)

11e switch transistor (first switch transistor)

12a, 12b gate driver circuit

14 source driver circuit

15, 115 organic EL element (light-emitting element)

16 pixel

17 scan line

18 data line

19, 119 capacitance element

20 display screen

22a, 22b reference power line

23 EL anode power line

24 EL cathode power line

25 initialization power line

27a, 27b reference voltage control line

28 initialization control line

31, 32 circuit

34 COF

35a, 35b gate printed circuit board

36 source printed circuit board

42 anode voltage generation circuit

44 cathode voltage generation circuit

46 Vini voltage generation circuit

48 Vref1 voltage generation circuit (second voltage source)

50 Vref2 voltage generation circuit (first voltage source)

1. A display device comprising
a plurality of pixels arranged in a matrix,
wherein each of the plurality of pixels includes:
a light-emitting element which emits light when a current flows through the light-emitting element;
a capacitance element which accumulates an electric charge corresponding to a magnitude of a video signal applied to a data line;
a drive transistor which supplies, to the light-emitting element, a current corresponding to an amount of the electric charge accumulated in the capacitance element;
a first switch transistor for pre-initializing the electric charge accumulated in the capacitance element; and
a second switch transistor for, after the pre-initializing, further initializing the electric charge accumulated in the capacitance element, and
the display device further comprises:
a first voltage source which outputs a first voltage to the capacitance element when the first switch transistor is turned on; and
a second voltage source which applies a second voltage to the capacitance element when the second switch transistor is turned on.

2. The display device according to claim 1,
wherein the first voltage and the second voltage have different values.

3. The display device according to claim 2,
wherein the first voltage is greater than the second voltage.

4. A method for driving a display device including a plurality of pixels arranged in a matrix, the method comprising:
pre-initializing an electric charge accumulated in a capacitance element disposed in each of the plurality of pixels;
after the pre-initializing, initializing again the electric charge accumulated in the capacitance element;
detecting a threshold voltage of a drive transistor disposed in each of the plurality of pixels;
accumulating, in the capacitance element, an electric charge corresponding to a magnitude of a video signal; and
supplying, to the light-emitting element, a current corresponding to an amount of the electric charge accumulated in the capacitance element to cause the light-emitting element to emit light.

5. The method according to claim 4,
wherein, in the pre-initializing, a first voltage is applied to the capacitance element from a first voltage source by turning on a first switch transistor; and
in the initializing, a second voltage is applied to the capacitance element from a second voltage source by turning on a second switch transistor.

6. The method according to claim 5,
wherein the first voltage and the second voltage have different values.

7. The method according to claim 6,
wherein the first voltage is greater than the second voltage.
